(19) United States
(12) Patent Application Publication
(10) Pub. No.: US 2015/0199454 A1
(43) Pub. Date: Jul. 16, 2015

(54) CONCURRENT DESIGN AND ANALYSIS OF AN ENGINEERING OBJECT

(71) Applicant: Brigham Young University, Provo, UT (US)

(72) Inventors: Ammon I. Hepworth, Provo, UT (US); Jared C. Briggs, Payson, UT (US); Brett R. Stone, Lehi, UT (US); Josh Q. Coburn, Orem, UT (US); Charles Greg Jensen, Provo, UT (US); Walter Edward Red, Provo, UT (US)

(21) Appl. No.: 14/595,011

(22) Filed: Jan. 12, 2015

Related U.S. Application Data
(60) Provisional application No. 61/926,011, filed on Jan. 10, 2014.

(51) Int. Cl. G06F 17/50; H04L 29/08

(52) U.S. Cl. CPC G06F 17/50; H04L 67/10

(57) ABSTRACT

A computer-implemented method for concurrent design and analysis of an engineering object may include (1) storing a geometric model of an engineering object, the geometric model including control points and analysis nodes derived from the control points, (2) enabling an analysis user to view the geometric model and perform analysis operations on analysis nodes, (3) enabling a CAD user to view the geometric model and edit a control point, and (4) updating the view of the geometric model provided to the CAD user and the analysis user according to the edit performed on the control point. Various other methods and systems are also disclosed herein.

### CROSS-REFERENCE TO RELATED APPLICATIONS

This application claims the benefit of U.S. provisional application 61/926,011 entitled “Synchronous, Multi-User, Integrated Design and Analysis: A Fundamental Approach” and filed on 10 Jan. 2014. The foregoing application is incorporated herein by reference.

### BACKGROUND

1. Technical Field

The subject matter disclosed herein relates generally to systems and methods for concurrent design and analysis of an engineering object.

2. Discussion of the Background

While computer-aided design (CAD) and engineering analysis tools such as finite element analysis (FEA) tools have closely related purposes in the engineering design process, they have developed as sets of separate and distinct tools. Throughout their development, design and analysis have retained significant differences in their methods of geometric representation that have made integration and interoperability of the two sets of tools difficult to achieve.

The lack of integration between design and analysis tools may present a number of problems. For example, mistakes may be introduced when transitioning a model from design tools to analysis tools. The transition process can also involve a significant amount of time and user effort, and may require additional user training. Having to transition a model from design tools to analysis tools typically implies that design and analysis are separate phases of the product development process. Design tool users and analysis tool users may not be able to work on the same model concurrently. Additionally, when the analysis process indicates that design changes are required, the process of transitioning the model from design to analysis may need to be repeated, often several times.

Given the foregoing, what is needed is additional and improved systems and methods for computer-assisted design and analysis of engineering objects, in particular, systems and methods that facilitate multiple simultaneous users. The embodiments disclosed herein were developed in response to these issues.

### SUMMARY OF THE INVENTION

As will be described in greater detail below, the subject matter disclosed herein describes various systems and methods for concurrent design and analysis of an engineering object. In one example, a computer-implemented method for concurrent design and analysis of an engineering object includes (1) storing a geometric model of an engineering object, the geometric model including control points and analysis nodes derived from the control points, (2) enabling an analysis user to view the geometric model and perform analysis operations on analysis nodes, (3) enabling a CAD user to view the geometric model and edit a control point, and (4) updating the view of the geometric model provided to the CAD user and the analysis user according to the edit that was performed on the control point.

In one embodiment, the geometric model is an isogeometric model. In one embodiment, the computer-implemented method further includes enabling the analysis user to add at least one additional analysis node to a geometry. In one embodiment, the analysis nodes are derived from the control points and a knot vector that includes at least one knot point. Updating the view of the geometric model may include updating the spatial position of the analysis nodes to conform to the control points and knot vector. In one embodiment, the analysis operation performed on the analysis node persists despite the update in the spatial position of the analysis node. Examples of analysis operations include applying a load and defining a boundary condition.

In one embodiment, the view of the geometric model provided to the CAD user does not show the analysis nodes. In some examples, the computer-implemented method may further include blocking the analysis user from editing the control points. In one embodiment, the control points are associated with B-splines, T-splines, and/or Bezier curves.

In one example, a method for concurrent design and analysis of an engineering object includes (1) storing a geometric model of an engineering object, the geometric model including control points and analysis nodes derived from the control points, (2) receiving, from a CAD user, a design operation that edits at least one of the control points, (3) receiving, from an analysis user, an analysis operation to be performed on analysis nodes of the geometric model, and (4) conducting the design operation on the geometric model concurrent with conducting the analysis operation.

In one embodiment, the method may further include (1) allocating several processing instances, of which each processing instance is to perform an operation on the geometric model and (2) assigning the design operation to a first processing instance and the analysis operation to a second processing instance. In one example, the first processing instance and the second processing instance are executed on the same processor or array of processors. In one example, the first processing instance and the second processing instance are executed on different processors or arrays of processors.

In one embodiment, a system for implementing the above-described methods may include several modules stored in memory, such as (1) a modeling module that stores a geometric model of an engineering object, the geometric model including control points and analysis nodes derived from the control points, (2) an analysis module that enables an analysis user to view the geometric model and perform analysis operations on analysis nodes, (3) a design module that enables a CAD user to view the geometric model and edit a control point, (4) an update module that updates the view of the geometric model provided to the CAD user and the analysis user according to the edit that was performed on the control point. The system may also include one or more physical processors configured to execute the modeling module, the analysis module, the design module, and the update module

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic drawing of a system for concurrent design and analysis of an engineering object;

FIG. 2 is a functional block diagram depicting one embodiment of the system for concurrent design and analysis of an engineering object;

FIG. 3 is a flowchart diagram depicting one embodiment of a method for concurrent design and analysis of an engineering object;

FIG. 4 is a flowchart diagram depicting one embodiment of a method for concurrent design and analysis of an engineering object;

FIG. 5 is a block diagram depicting design and analysis views of an engineering object; and

FIG. 6 is a block diagram depicting design and analysis views of an engineering object.

FIG. 7 is a block diagram depicting an analysis view of an engineering object.

### DETAILED DESCRIPTION

Some of the functional units described in this specification have been labeled as modules, in order to more particularly emphasize their implementation independence. Others are assumed to be modules. For example, a module or similar unit of functionality may be implemented as a hardware circuit comprising custom VLSI circuits or gate arrays, off-the-shelf semiconductors such as logic chips, transistors, or other discrete components. A module may also be implemented with programmable hardware devices such as field programmable gate arrays, programmable array logic, programmable logic devices or the like.

A module or a set of modules may also be implemented (in whole or in part) as a processor configured with software to perform the specified functionality. An identified module may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, enable the module to achieve the intended purpose for the module.

Indeed, the executable code of a module may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any tangible form capable of enabling execution of a program of machine-readable instructions on a digital processing apparatus. For example, a computer readable medium may be embodied by a flash drive, compact disk, digital-video disk, a magnetic tape, a magnetic disk, a punch card, flash memory, integrated circuits, or other digital processing apparatus memory device. A digital processing apparatus such as a computer may store program codes, associated data, and the like on the computer readable medium that when retrieved enable the digital processing apparatus to execute the functionality specified by the modules.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The present disclosure is generally directed to systems and methods for concurrent design and analysis of an engineering object. As will be explained in greater detail below, using a geometric model of an engineering object that includes control points and analysis nodes derived from the control points, systems and methods described herein may enable an analysis user to perform analysis operations on analysis nodes while a CAD user concurrently edits control points. Systems and methods described herein may provide views of the geometric model to CAD users and analysis users that are updated in real time as design and analysis operations are performed.

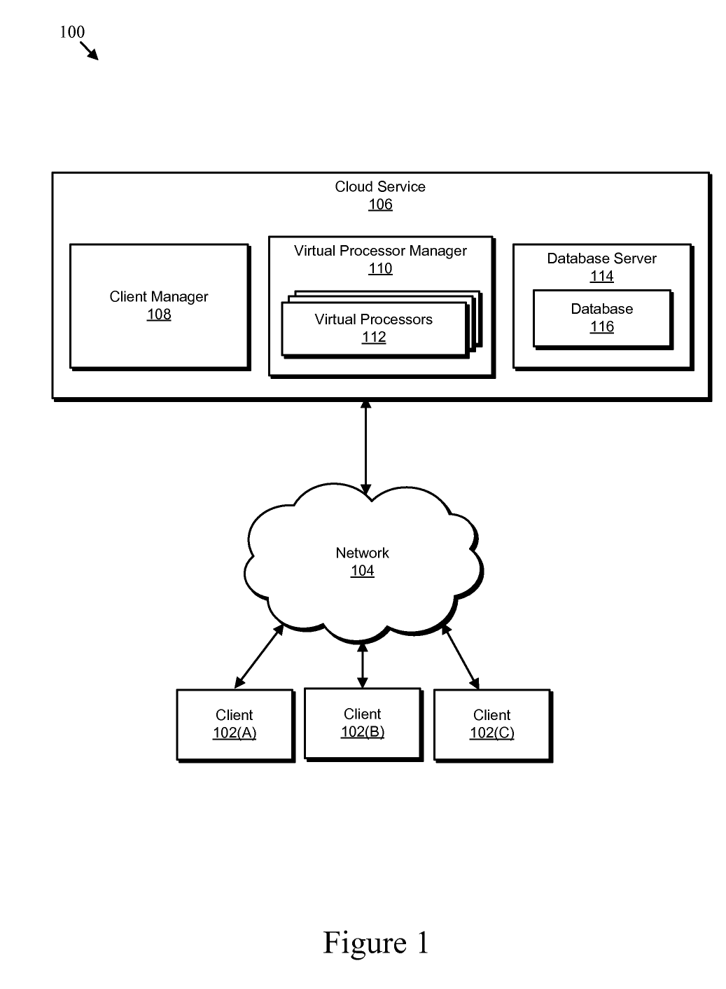

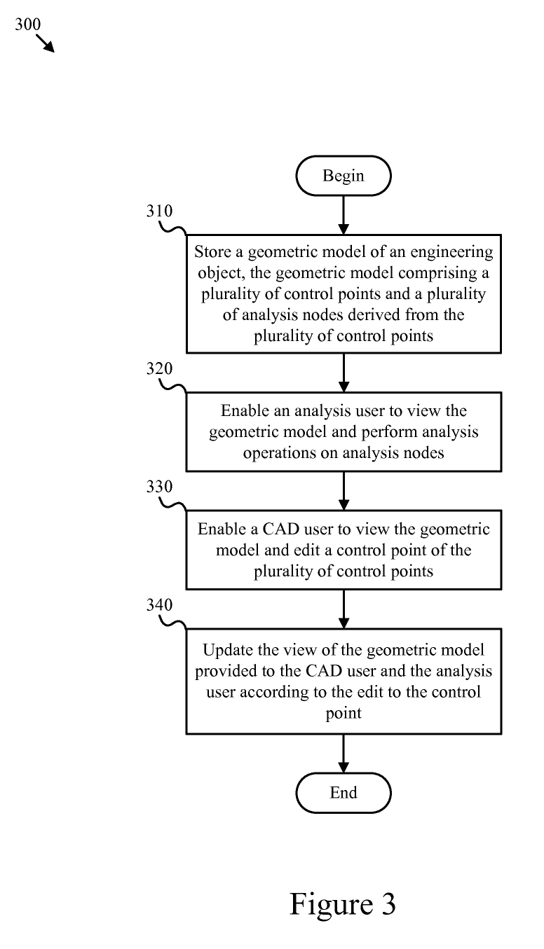

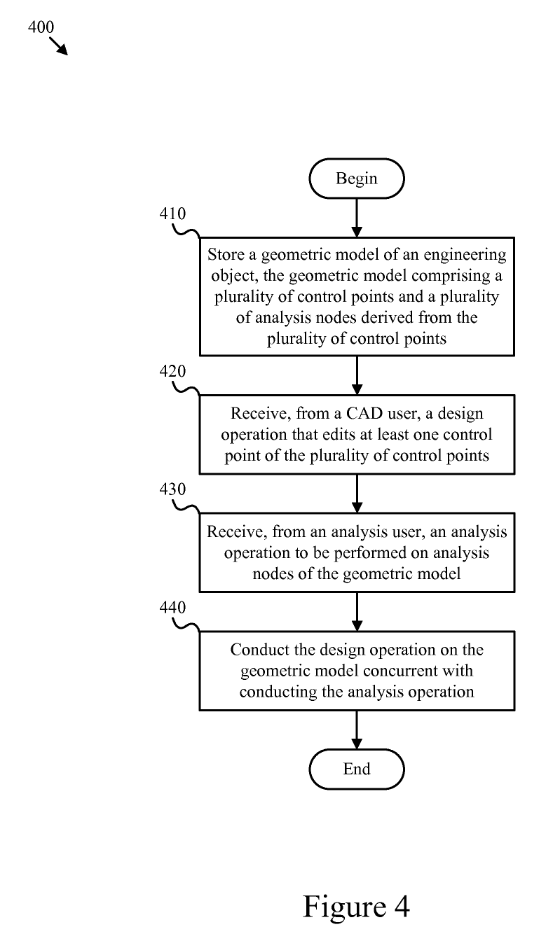

The following will provide, with reference to FIGS. 1, 2, 5, 6, and 7 detailed descriptions of exemplary systems for concurrent design and analysis of an engineering object. Detailed descriptions of corresponding computer-implemented methods will also be provided in connection with FIGS. 3 and 4.

FIG. 1 is a schematic drawing of an environment 100 wherein concurrent design and analysis may be deployed. As illustrated in this figure, environment 100 may include one or more clients 102, a network 104, and a cloud service 106. Cloud service 106 may include one or more computing systems, such as client manager 108, virtual processor manager 110, and database server 114.

Clients 102 generally represent any type or form of computing device capable of reading computer-executable instructions. Examples of clients 102 include, without limitation, laptops, tablets, desktops, servers, combinations of one or more of the same, or any other suitable computing device.

Cloud service 106 generally represents any type or form of computing device or combinations of computing devices that is capable of storing, comparing, and/or providing data, as well as providing back-end processing services. Cloud service 106 may represent a commercial or publicly-accessible service or a service provided to a single organization. Examples of cloud service 106 include, without limitation, high-performance clusters, virtual machines, application servers, web servers, and/or database servers configured to provide various database services and/or run software applications, or combinations of one or more of the same.

In certain embodiments, cloud service 106 may represent combinations of software applications and physical computing systems configured to perform various tasks. For example, cloud service 106 may include client manager 108, virtual processor manager 110 that manages a set of one or more virtual processors 112, and a database server 114 that manages one or more databases, such as database 116. In one example, database 116 may be configured to store geometry, material, load, and/or environment data representing one or more design models. Database 116 may represent portions of a single database or computing device or a plurality of databases or computing devices capable of being accessed by computing devices included in cloud service 106 and/or clients 102.

Network 104 generally represents any medium or architecture capable of facilitating communication or data transfer. Examples of network 104 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), or the like. Network 104 may facilitate communication or data transfer using wireless or wired connections. In one embodiment, network 104 may facilitate communication between clients 102 and cloud service 106.

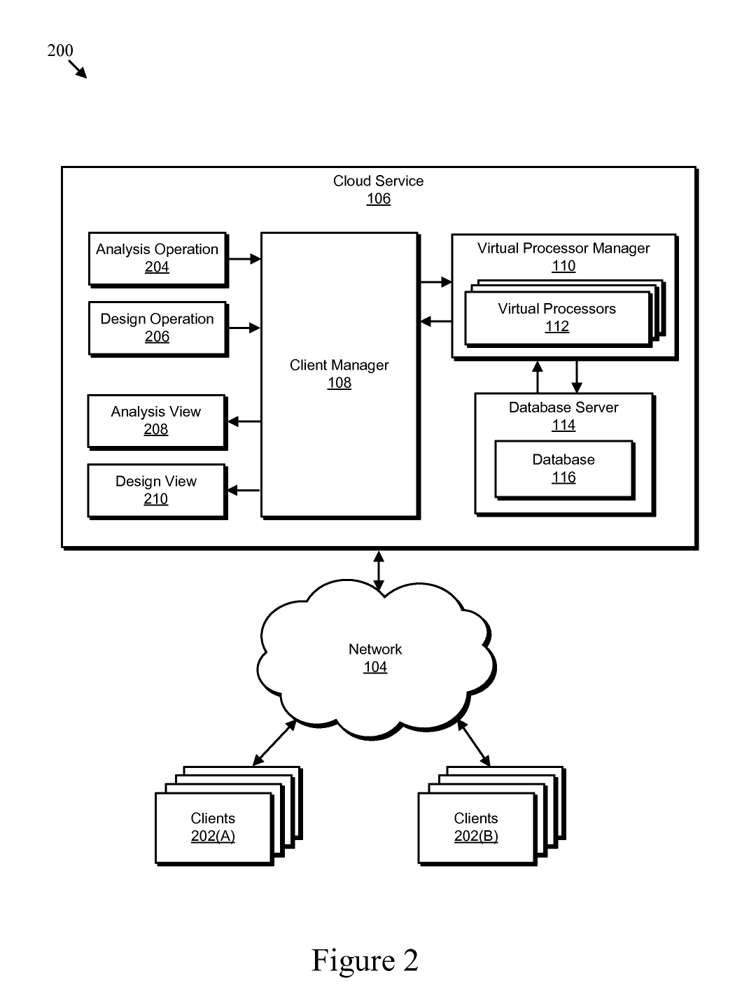

FIG. 2 is a functional block diagram depicting one embodiment of a concurrent design and analysis system 200 that includes two groups of clients 202(A) and 202(B) that may represent groups of client computing systems allocated to separate design and/or analysis groups or to subsystems of a single design model. Database server 114 may maintain separate databases or database partitions for each group of clients 202. This approach may prove advantageous when the cloud service provides services to multiple organizations, groups within a single organization, or for multiple projects. In addition to maintaining data separation and integrity, database management functions may more closely mirror project management operations. Maintaining separate databases or database partitions may also fulfil legal requirements, for example for restrictions required under International Traffic in Arms Regulations (ITAR).

Database server, as part of cloud service 106, may store a geometric model in database 116, including control points and analysis nodes derived from the control points. As will be described in greater detail below, client manager may provide analysis view 208, enabling an analysis user to view the geometric model and perform analysis operations 204 on analysis nodes. Client manager 108 may also provide design view 210, enabling a CAD user to view the geometric model and edit a control point via design operation 206. When the control point has been updated in database 116, client manager 108 may update design view 210 of the geometric model provided to the CAD user and analysis view 208 for the analysis user according to the edit that was performed on the control point included in design operation 206. Client manager 108 may receive, from a CAD user using a client 202, a design operation 206 that edits at least one of the control points. Client manager 108 may also receive, from an analysis user on another client 202, an analysis operation 204 to be performed on analysis nodes of the geometric model. Virtual processor manager 110 may allocate a virtual processor 112 to conduct design operation 206 on the geometric model and a virtual processor 112 to conduct analysis operation 204 concurrent with design operation 206.

FIG. 3 is a flowchart depicting one embodiment of a concurrent design and analysis method 300. The steps shown in FIG. 3 may be performed by any suitable computer-executable code and/or computing system. In some embodiments, the steps shown in FIG. 3 may be performed by one or more of the components of system 100 in FIG. 1 or system 200 in FIG. 2.

As illustrated in FIG. 3, at step 310 of method 300, one or more of the systems described herein may store a geometric model of an engineering object. The geometric model may include control points and analysis nodes derived from the control points. For example, a modeling module may, as part of client manager 108 in cloud service 106 in FIG. 2, store a geometric model of an engineering object in database 116. In some embodiments, an analysis node may occupy the same spatial position as a control point. However, generally there are many more analysis nodes than control points.

As used herein, the term “control point” generally refers to a set of values in three-dimensional space that is used to determine the shape of a spline, curve, or higher-dimensional object, such as a surface. In the case of NURBS and other rational splines, control points have an associated weighting value. Control points determine the shape of the spline, curve, or other object. For example, each point of the shape may be computed by taking a weighted sum of a number of control points.

In one embodiment, the analysis nodes are derived from the control points and a knot vector that includes at least one knot point. As used herein, the term “analysis node” generally refers to spatial positions at which discrete subregions or elements are connected to form a model of an engineering object. Loads, displacements, and/or boundary conditions may be associated with analysis nodes. As used herein, the term “knot vector” generally refers to a sequence of parameter values that determines where and how the control points affect the curve. Each parameter value is referred to as a “knot.” Knots are points where the pieces of a piecewise polynomial function join to form a spline or other curve.

A modeling module may store a geometric model of an engineering object in a variety of ways. For example, a modeling module may associate control points with B-splines, T-splines, and/or Bezier curves. As used herein, the term “B-spline” or “basis spline” generally refers to a spline function that has minimal support with respect to a given degree, smoothness, and domain partition. B-splines are polynomial functions that may be joined to form a spline function. NURBS are a form of B-spline. As used herein, the term “T-spline” generally refers to a curve similar to a NURBS curve that may be used to define a surface. T-splines differ from NURBS in that T-splines may include T-points, i.e., partial isoparms. A T-point is a vertex that has an isoparm without another isoparm on the opposite side. As used herein, the term “Bezier curve” generally refers to a parametric curve that differs from a B-spline in that control points lack rationalization (i.e., a weight value).

In one example, the geometric model stored by the modeling module is an isogeometric model. As used herein, the term “isogeometric model” generally refers to a geometric model in which analysis elements and shape functions can be derived directly from the geometry model. Since isogeometric models use a single model for both design and analysis, translation between design tools and analysis tools may not be required.

At step 320, one or more of the systems described herein may enable an analysis user to view the geometric model and perform analysis operations on analysis nodes. For example, an analysis module may, as part of client manager 108 and/or a client 202 in FIG. 2, enable an analysis user to view the geometric model by providing analysis view 208 and perform analysis operation 204 on analysis nodes included in the geometric model stored in database 116.

An analysis module may enable an analysis user to view the geometric model and perform analysis operations on analysis nodes in a variety of ways and in a variety of contexts. For example, an analysis operation performed on one or more analysis nodes may persist at an updated spatial position. In another example, an analysis module may block the analysis user from editing control points that define a geometry, allowing only design users to edit control points. In some examples, the analysis operation may include applying a load to one or more analysis nodes. In some examples, the analysis operation may include defining a boundary condition at one or more analysis nodes. In some examples, the analysis module enables an analysis user to increase the number of analysis nodes in a region of the geometry. Increasing the number of analysis nodes may be accomplished by performing knot insertion on the region of the geometry.

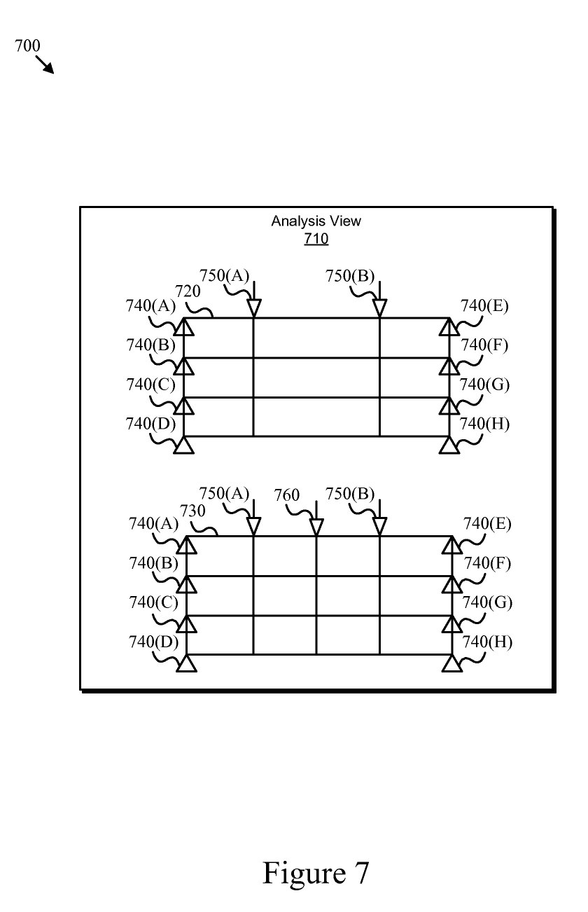

In one example, an analysis module may enable an analysis user to add additional analysis nodes to a geometry. FIG. 7 depicts a view 700 of a geometry in a geometric model. View 700 includes an analysis view 710. Analysis view 710 includes a view 720 of a meshed geometry before additional analysis nodes are added to the geometry, and a view 730 of the geometry after analysis nodes are added. View 720 includes boundary conditions 740(A)-(H) and loads 750(A) and (B). View 730 includes an additional load 760 added to the geometry at the top analysis node of a column of analysis nodes that have been added to the geometry.

At step 330, one or more of the systems described herein may enable a CAD user to view the geometric model and edit one or more control points. For example, a design module may, as part of client manager 108 and/or a client 202 in FIG. 2, enable a CAD user using a client 202 to edit one or more control points by receiving design operation 206 from the design user. The design module may enable the CAD user to view the geometric model stored in database 116 by providing design view 210 to the design user using a client 202.

A design module may enable a CAD user to view the geometric module and edit one or more control points in a variety of ways. For example, a design module may omit analysis nodes from the view of the geometric model provided to the CAD user, and provide analysis nodes only in views provided to analysis tool users. Editing a control point may include creating a new control point. In some examples, a geometry operation may result in the insertion of additional knots in the geometry, and an increase in the number of analysis nodes in the geometry. The design module may still block the CAD user from viewing and/or editing the analysis nodes.

At step 340, one or more of the systems described herein may update the view of the geometric model provided to the CAD user and the analysis user according to the edit that was performed on the control point. For example, an update module may, as part of client manager 108 and/or a client 202 in FIG. 2, update design view 210 of the geometric model stored in database 116 provided to the CAD user according to the edit that was performed on the control point included in design operation 206. The update module may also update analysis view 208 of the geometric model provided to the analysis user according to the edit that was performed on the control point included in design operation 206.

An update module may update views of the geometric model provided to the design user and the analysis user in a variety of ways. For example, an update module may update the view of the geometric model for an analysis user by updating a spatial position of an analysis node.

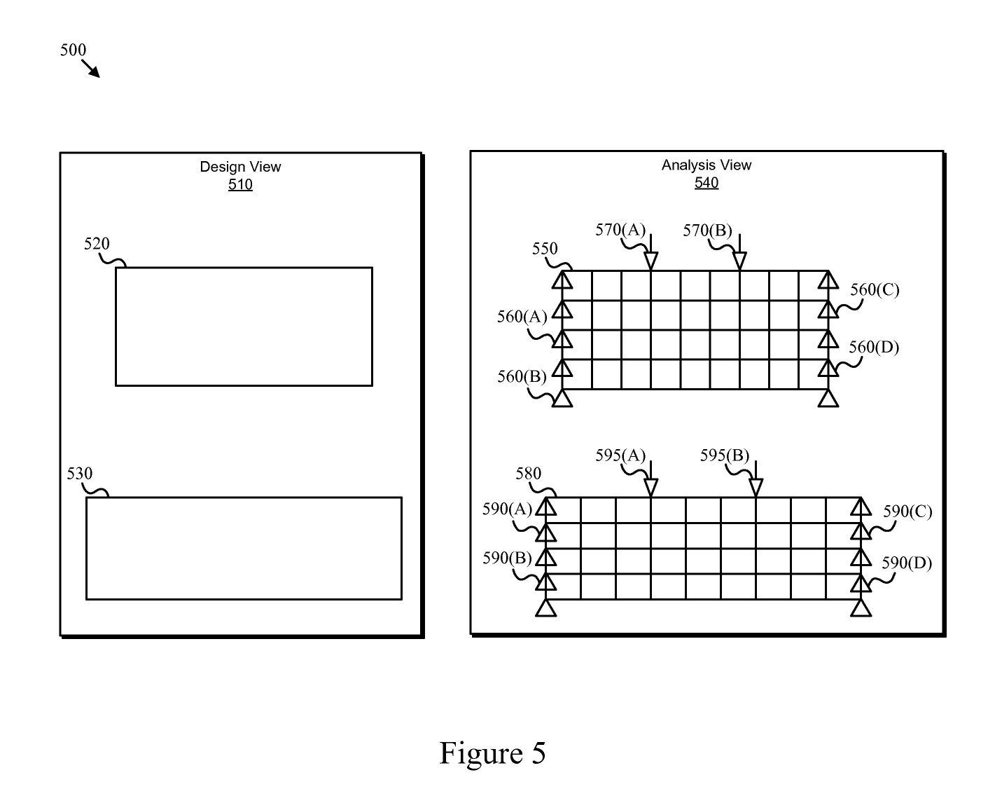

FIG. 5 depicts corresponding design and analysis views 500 of a geometry in a geometric model that may be displayed concurrently to design and analysis users. Concurrent views 500 include design view 510, which includes two views of a beam geometry 520 and 530 before and after the beam is resized. Concurrent views 500 also includes analysis view 540, which includes two views 550 and 580 of a meshed geometry corresponding to design views 520 and 530 of the beam, before and after the beam is resized. Meshed geometry 550 includes boundary conditions 560(A)-(D) (in addition to other unlabeled boundary conditions) and loads 570(A) and (B). When meshed geometry 550 is resized as geometry 580, boundary conditions 560(A)-(D) are transformed to boundary conditions 590(A)-(D), remaining at the corresponding locations on the resized geometry. Likewise, loads 570(A) and (B) are transformed to loads 595(A) and (B), remaining at corresponding locations on the resized geometry.

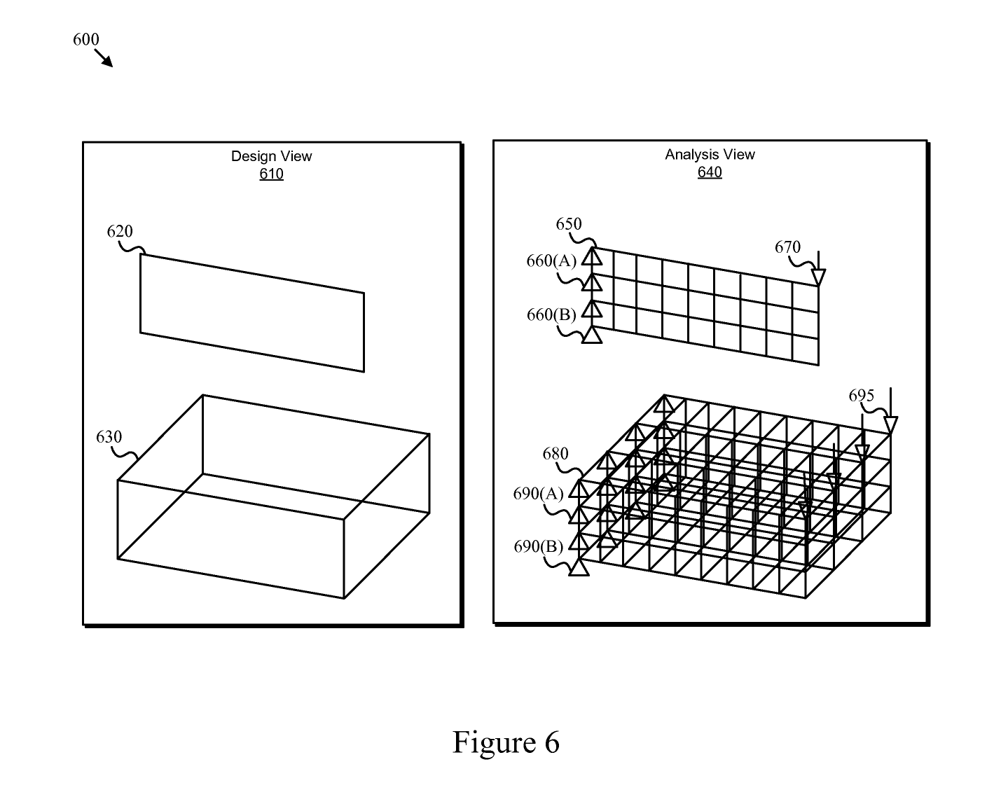

FIG. 6 depicts corresponding design and analysis views 600 of a geometry of a geometric model that may be displayed concurrently to design and analysis users. Concurrent views 600 include design view 610, which includes two views of a cantilever beam geometry 620 and 630 before and after the beam is extruded from a surface. Concurrent views 600 also includes analysis view 640, which includes two views 650 and 680 of a meshed geometry corresponding to design views 620 and 630, before and after the beam is extruded from the surface. Meshed geometry 650 includes boundary conditions 660(A) and (B) (in addition to other unlabeled boundary conditions) and load 670. When meshed geometry 650 is extruded from the surface as geometry 680, boundary conditions 660(A) and (B) are transformed to boundary conditions 690(A) and (B), remaining at the corresponding locations on the resulting geometry. In response to extrusion along a new dimension, additional boundary conditions are created at corresponding positions on the end of the extruded beam along the new dimension. Likewise, loads 695 corresponding to load 670 are created at the resulting edge of the extruded geometry.

FIG. 4 is a flowchart diagram of a concurrent design and analysis method 400. The steps shown in FIG. 4 may be performed by any suitable computer-executable code and/or computing system. In some embodiments, the steps shown in FIG. 4 may be performed by one or more of the components of system 100 in FIG. 1 or system 200 in FIG. 2.

As illustrated in FIG. 4, at step 410 of method 400, one or more of the systems described herein may store a geometric model of an engineering object, with the geometric model including control points and analysis nodes derived from the control points. For example, a modeling module may, as part of client manager 108 in cloud service 106 in FIG. 2, store a geometric model of an engineering object in database 116.

At step 420, one or more of the systems described herein may receive, from a CAD user, a design operation that edits one or more of the control points included in the geometric model. For example, a communication module may, as part of client manager 108 in cloud service 106 in FIG. 2, receive, from a CAD user, a design operation 206 that edits one or more of the control points in the geometric model stored in database 116.

A communication module may receive a design operation in a variety of ways. For example, clients 202 may be thin clients that perform minimal design functions, but instead primarily display views of the geometric model and receive user input to be submitted to the cloud service as design operations to be applied to the geometric model. A communication module may receive design operations as a description of one or more selected geometries with a description of the operation to be performed by the cloud service in relation to the selected geometries.

At step 430, one or more of the systems described herein may receive, from an analysis user, an analysis operation to be performed on analysis nodes of the geometric model. For example, a communication module may, as part of client manager 108 in cloud service 106 in FIG. 2, receive, from an analysis user using a client 202, analysis operation 204 to be performed on analysis nodes of the geometric model stored in database 116.

A communication module may receive analysis operations in any suitable manner. For example, as with design operations a communication module may receive user input from a thin client 202 that specifies analysis nodes selected by the user, along with analysis operations to be performed on the selected analysis nodes.

At step 440, one or more of the systems described herein may conduct the design operation on the geometric model concurrent with conducting the analysis operation. For example, a processor allocation module may, as part of virtual processor manager 110 in FIG. 2, allocate a virtual processor 112 to conduct design operation 206 on the geometric model and a virtual processor 112 to conduct analysis operation 204 concurrent with design operation 206.

A processor allocation module may conduct concurrent design and analysis operations in any suitable manner. For example, a processor allocation module may allocate several virtual processors, with each virtual processor to perform an operation on the geometric model, and assign the design operation to a first virtual processor and the analysis operation to a second virtual processor. In some examples, the first virtual processor and the second virtual processor instance may be executed on the same physical processor or array of processors. In other examples, the first virtual processor and the second virtual processor are executed on different physical processors or arrays of processors.

In some examples, virtual processor manager 110 provides an operation queue for submitting design and/or analysis operations for assignment to an instance of a virtual processor. The operation queue may be implemented as a priority queue that identifies design and/or analysis operations that must be completed before lower-priority operations begin processing. Virtual processor manager 110 may also provide a results queue that collects results from processing operations for distribution to clients and updating of the geometric database.

In some embodiments, virtual processor manager 110 maintains a pool of virtual processors 112 that are available to receive and perform design and/or analysis operation assignments. Maintaining a pool of available virtual processors may reduce the overhead of allocating memory and spawning processes and threads as each operation is added to the operation queue. Over time, virtual processor manager 110 may adjust the number of virtual processors 112 available in the pool, to optimize throughput and resource utilization.

Virtual processor manager 110 may manage the pool of virtual processors 112 in a variety of ways. Although it may be possible to service the operation queue using a cluster of physical computing systems, one of skill in the art will recognize the throughput advantages associated with the use of virtual processors. Virtual processors 112 may consist of separate application program instances running on a single computing system or cluster of computing systems, each program instance having its own thread group and allocated memory. In other examples, virtual processors 112 may be virtual machines such as VMWARE ESX, MICROSOFT HYPER-V, or ORACLE VM SERVER.

As described above, the systems and methods described herein may use a geometric model of an engineering object to perform design and analysis operations concurrently. The geometric module may include control points and analysis nodes derived from the control points. Systems and methods described herein may provide views of the geometric model to CAD users and analysis users that are updated in real time as design and analysis operations are performed. By concurrently performing design and analysis operations, systems and methods described herein may eliminate the design-transition-analysis cycle, replacing it with a less constrained workflow that may facilitate greater collaboration between design tool users and analysis tool users. Systems and methods described herein may decrease product development time by eliminating the need to transition models from design tools to analysis tools, as well as reducing the user training involved in learning the transition process, and eliminating design errors that may be introduced during model transition.

In summary, the methods, apparatuses, and systems presented herein provide a number of distinct advantages over prior art methods, apparatuses, and systems. It should be noted that many of the functional units described herein are identified as modules. Others are assumed to be modules. Others are assumed to be modules. One of skill in the art will appreciate that the various modules described herein may include a variety of hardware components that provide the described functionality including one or more processors such as CPUs or microcontrollers, or programmable logic devices (i.e., hardware components) that are configured by one or more software components. The software components may include executable instructions or codes and corresponding data that are stored in a computer-readable storage medium such as a non-volatile memory, or the like. The instructions or codes may include machine codes that are configured to be executed directly by the processor. Alternatively, the instructions or codes may be configured to be executed by an interpreter, or the like, that translates the instructions or codes to machine codes that are executed by the processor.

It should also be understood that this description is not intended to limit the invention. On the contrary, the exemplary embodiments are intended to cover alternatives, modifications, and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method, executed by one or more computers, for concurrent design and analysis of an engineering object, the method comprising:
storing a geometric model of an engineering object, the geometric model comprising a plurality of control points and a plurality of analysis nodes derived from the plurality of control points;
enabling an analysis user to view the geometric model and perform analysis operations on analysis nodes;
enabling a CAD user to view the geometric model and edit a control point of the plurality of control points;
updating the view of the geometric model provided to the CAD user and the analysis user according to the edit performed on the control point.

2. The method of claim 1, wherein the geometric model comprises an isogeometric model.

3. The method of claim 1, further comprising enabling the analysis user to add at least one additional analysis node to a geometry.

4. The method of claim 1, wherein the analysis nodes are derived from the plurality of control points and a knot vector comprising at least one knot point.

5. The method of claim 1, wherein updating the view of the geometric model comprises updating a spatial position of an analysis node.

6. The method of claim 5, wherein an analysis operation performed on the analysis node persists despite the update in the spatial position.

7. The method of claim 6, wherein the analysis operation comprises at least one of:
applying a load;
defining a boundary condition.

8. The method of claim 1, wherein the view of the geometric model provided to the CAD user does not show the plurality of analysis nodes.

9. The method of claim 1, further comprising blocking the analysis user from editing the control points.

10. The method of claim 1, wherein the plurality of control points are associated with at least one of:
a plurality of B-splines;
a plurality of T-splines;
a plurality of Bezier curves.

11. A method, executed by one or more computers, for concurrent design and analysis of an engineering object, the method comprising
storing a geometric model of an engineering object, the geometric model comprising a plurality of control points and a plurality of analysis nodes derived from the plurality of control points;
receiving, from a CAD user, a design operation that edits at least one control point of the plurality of control points;
receiving, from an analysis user, an analysis operation to be performed on analysis nodes of the geometric model;
conducting the design operation on the geometric model concurrent with conducting the analysis operation.

12. The method of claim 10, further comprising:
allocating a plurality of processing instances, each processing instance to perform an operation on the geometric model;
assigning the design operation to a first processing instance and the analysis operation to a second processing instance.

13. The method of claim 12, wherein the first processing instance and the second processing instance are executed on the same processor or array of processors.

14. The method of claim 12, wherein the first processing instance and the second processing instance are executed on different processors or arrays of processors.

15. A system for concurrent design and analysis of an engineering object, the system comprising:
a modeling module, stored in memory, that stores a geometric model of an engineering object, the geometric model comprising a plurality of control points and a plurality of analysis nodes derived from the plurality of control points;
an analysis module, stored in memory, that enables an analysis user to view the geometric model and perform analysis operations on analysis nodes;
a design module, stored in memory, that enables a CAD user to view the geometric model and edit a control point of the plurality of control points;
an update module, stored in memory, that updates the view of the geometric model provided to the CAD user and the analysis user according to the edit performed on the control point;
at least one physical processor configured to execute the modeling module, the analysis module, the design module, and the update module.

16. The system of claim 15, further comprising:
a communication module that receives analysis operations to be performed on analysis nodes of the geometric model;
the communication module receives design operations that edit at least one control point of the plurality of control points;
a processor allocation module that allocates a plurality of processing instances, each processing instance to perform an operation on the geometric model.

17. The system of claim 16, wherein:
the communication module receives, from the CAD user, a design operation that edits at least one control point of the plurality of control points;
the communication module receives, from the analysis user, an analysis operation to be performed on analysis nodes of the geometric model;
the processor allocation module assigns the design operation to a first processing instance and the analysis operation to a second processing instance, the processing instances to conduct the design operation on the geometric model concurrent with conducting the analysis operation.

18. The system of claim 17, wherein the first processing instance and the second processing instance are executed on the same processor or array of processors.

19. The system of claim 17, wherein the first processing instance and the second processing instance are executed on different processors or arrays of processors.

20. The system of claim 15:
wherein the view of the geometric model provided to the CAD user does not show the plurality of analysis nodes;
further comprising blocking the analysis user from editing the control points.
